(19) United States
(12) Patent Application Publication
(10) Pub. No.: US 2007/0225062 A1
(43) Pub. Date: Sep. 27, 2007

(54) Gaming machine

(75) Inventor: Katsumi Yamaguchi, Tokyo (JP)

Correspondence Address: SNIDER & ASSOCIATES, P. O. BOX 27613, WASHINGTON, DC, 20038-7613, US

(73) Assignee: Aruze Corp., Tokyo (JP)

(21) Appl. No.: 11/723,126

(22) Filed: Mar. 16, 2007

(30) Foreign Application Priority Data
Mar. 22, 2006 (JP) 2006-078720

(51) Int. Cl. A63F 13/00

(52) U.S. Cl. 463/20

(57) ABSTRACT

A gaming machine according to the invention comprises: time input units 15 and 16 in which a time is inputted from outside the cabinet; a time storage unit 74 which stores the time inputted utilizing the time input units 15 and 16; a time measuring unit 78 which measures a current time, which is operated on an internal power source; and a time indicating unit (2a) which indicates that the time inputted has arrived when a determination is made that the current time measured by the time measuring unit 78 is the inputted time stored in the time storage unit 74.

### RELATED APPLICATIONS

This application claims the priority of Japanese Patent Application No. 2006-078720 filed on Mar. 22, 2006, which is incorporated herein by reference.

### BACKGROUND OF THE INVENTION

1. Field of the Invention

The present invention relates to a gaming machine that comprises a variable display device for variably displaying symbols or the like and that provides an award to a player in accordance with the display mode of the symbols or the like that are displayed by the variable display device when the variable display stops varying.

2. Description of the Prior Art

Slot machines and pachinko gaming machines are widely known as gaming machines that comprise a plurality of reels having a plurality of types of symbols on a periphery surface of the reels, which rotate these reels and then stop rotating these reels, that pay out the gaming media in accordance with combinations of the symbol of each reel that are stopped and displayed on active pay lines, and that provide awards to a player. Generally, game starts and the reels rotate on a slot machine after a medal is inserted and a start lever is operated. Then the reels stop rotating when a stop switch is operated, and in the case in which a predetermined combination of the symbols is arranged on a pay line, in other words in the case of a win, a number of medals are paid out in accordance with the winning combination of the symbols. Also in pachinko gaming machines, when a pachinko ball is inserted into the start chucker provided on the gaming board, a plurality of symbols, which are displayed on a liquid crystal display provided in a gaming board or the like, are variably displayed, and when a predetermined time period passes, a so-called big winning develops if a predetermined combination of the symbols is displayed when the variable display stops.

Among slot machines described above there are ones such as disclosed in, for example, Japanese Unexamined Patent Publication No. 2002-263249 in which a time setting switch and a set time display portion are provided in the cabinet through which an intermission period can be set by a staff member of the game arcade. In this slot machine the staff member inserts a key into a lock for opening and closing the cabinet, in which the lock is provided on the front surface of the cabinet, and when the inserted key is set to the start position of the intermission display, time measuring set with the time setting switch described above is started, and during this period a display is made on a display device provided on the outer portion of the cabinet to the effect that the gaming machine is in intermission and the gaming machine is in a condition in which inserted medals are not accepted. Then when the set time arrives, the display, on the display device described above, to the effect that the gaming machine is in intermission, is ended and the gaming machine returns to a condition in which inserted medals are accepted.

Also a game arcade management system with the same function as the slot machine described above is disclosed in Japanese Unexamined Patent Publication No. 2004-187868. More specifically, in the game arcade management system, when contact information (for example a mobile phone number or an e-mail address) for a player is transmitted from a player owned mobile phone having an infrared communication function to an IrDA reception port of a display device provided corresponding to a gaming machine (for example a pachinko gaming machine), a control portion for controlling the gaming machine sets the handle of the pachinko gaming machine to a condition in which the handle cannot be operated, and turns on a lamp or the like comprised in the display device described above. Then a staff member of the game arcade recognizes that the lamp or the like is turned on and inputs a predetermined intermission period into the display device described above, after which the control portion described above starts measuring the input intermission period. When the intermission period has passed the control portion transmits the contact information the player input to an information processing terminal. The information processing terminal, which received this information, transmits to the player a message to the effect that the intermission period has ended. When the player who has received this message once more transmits his contact information to the IrDA reception port of the display device, the control device sets the handle of the pachinko gaming machine to a condition in which the handle can be operated.

However, when a player desires to play for a limited time or when the player desires to stop game at a predetermined time, the player himself must play while checking with a watch or the like whether the predetermined time has arrived. However, due to the spread of mobile phones in recent years there are players who use the clock function comprised in specialized mobile phones and who do not wear a watch, and in cases like this type of player, checking of whether the predetermined time has arrived must be performed with the clock of the mobile phone. Thus, the player cannot concentrate on the game due to frequent checking of the clock on the mobile phone or the player becomes overly absorbed in the game and forgets to check the clock on the mobile phone, thus there is a possibility of going past the predetermined time. Also it is possible to use the alarm function comprised in the mobile phone and have an alarm generated at the predetermined time, however, it is possible that the player will not notice the alarm due to noise and the like in the surrounding environment.

Furthermore, in both the slot machine and the game arcade management system described above the timing of starting the intermission is at the discretion of the player, thus when the player desires to interrupt the game to go to eat or the like, a staff member must perform the setting to start the intermission period, thus in each case it requires effort to call a staff member of the game arcade and the player cannot leave the gaming machine until the staff member performs the operation to start the intermission, in other words there is a hassle in that the player cannot go eat. Furthermore, setting of the intermission period is performed by a staff member of the game arcade, thus it is difficult to set the intermission period to the minimum time necessary according to the convenience of the player.

### SUMMARY OF THE INVENTION

In the present invention not only is there no risk of a player forgetting the predetermined time or time period even when the player is involved in a game, and not only does the present invention solve the trouble at the time of starting the intermission period, but the present invention has an object of providing a gaming machine in which setting of an intermission period can be performed according to the convenience of the player.

In order to achieve the object described above the present invention concerns a gaming machine which has a variable display means, provided in a cabinet, in which the variable display means variably displays identification information of a plurality of types, and in which the gaming machine performs game in which an award is provided to a player in accordance with a display state of the identification information displayed when a variable display in the variable display means stops, wherein the gaming machine has time input means for inputting a time from outside the cabinet, time storage means for storing the time inputted utilizing the time input means, time measuring means for measuring a current time, the time measuring means operated on an internal power source, and time indicating means for indicating that the time inputted has arrived when a determination is made that the current time measured by the time measuring means is the inputted time stored in the time storage means.

Here “identification information” concerns symbols, letters, numerical characters, signs and the like. A “variable display means” is one that performs variable display of symbols or the like by rotating reels on which peripheries the symbols or the like are drawn, or is an image display means that performs variable display by moving images of symbols or the like on a screen. “Provide an award” refers to for example a payout of gaming media such as a medal or a pachinko ball, or the like to a player. (Here the medals are used as gaming medium. However, it is not limited to medals but tokens, coins and the like may also be used as gaming media.) “Indication” refers to a display or the like using a sound, a lit or blinking light source such as a lamp, letters, numerical characters, shapes or the like.

Also the present invention concerns the gaming machine described above, wherein the gaming machine comprises time period input means for inputting a time period from outside the cabinet, time period storage means for storing the time period inputted utilizing the time period input means, time period measuring means for measuring the time period stored in the time period storage means, and game disable means for making a condition in which the game cannot be performed while the time period measuring means measures the time period stored in the time period storage means.

Further, the present invention concerns the gaming machine, wherein the time indicating means includes a display provided on a front surface side of the gaming machine.

Still further, in the gaming machine of the present invention, the variable display means includes a plurality of rotating reels, and wherein the time indicating means indicates when a condition exists in which rotation of all of the plurality of rotating reels is stopped.

Moreover, the gaming machine of the present invention further comprises data that associates each time zone in which the player can obtain an intermission with a maximum intermission period that can be obtained, wherein the time indicating means performs indicating only in a case in which the time inputted with the time input means is a time in one of the time zones in which the intermission can be obtained.

Further, the gaming machine of the present invention may be a slot machine.

Also the present invention concerns the gaming machine described above, wherein the gaming machine comprises input time period correction means for storing a predetermined time period in the time period storage means in place of a time period inputted with the time period input means, when the time period inputted utilizing the time period input means exceeds the predetermined time period.

Further, the present invention concerns the gaming machine, wherein the variable display means includes a plurality of rotating reels, the time indicating means is a display provided on a front side of the plurality of rotating reels, and the plurality of rotating reels are difficult to be seen from a front surface side of the gaming machine due to the display being in a light blocking condition while the game disable means is measuring the time period stored in the time period storage means.

Still further, in the gaming machine of the present invention, the time indicating means continuously indicates until a prescribed operation relating to the time period input is performed in the time period input means.

Moreover, in the gaming machine of the present invention, the variable display means includes a plurality of rotating reels, the display is provided on a front side of the plurality of rotating reels, and the display is normally transparent so that the plurality of rotating reels are visible from the front surface side of the gaming machine, and on the other hand when the time indicating means performs indicating, the plurality of rotating reels are difficult to see from the front surface side of the gaming machine due to the display being in a light blocking condition.

### BRIEF DESCRIPTION OF THE DRAWINGS

FIG. 1 is a front surface view showing a slot machine from an outer perspective as one example of a gaming machine in an embodiment of the present invention;

FIG. 2 is a block diagram showing the structure of a main control unit of the gaming machine in an embodiment of the present invention;

FIG. 3 is a block diagram showing the structure of a sub control unit of the gaming machine in an embodiment of the present invention;

FIGS. 4A and 4B are explanatory charts that explain the contents of a portion of data stored in a ROM provided in the sub control unit of the gaming machine in an embodiment of the present invention;

FIG. 5 is a flow chart that shows the flow of time setting indicating processing which is performed in the sub control unit of the gaming machine in an embodiment of the present invention;

FIG. 6 is a flow chart that shows the flow of alarm time setting processing which is performed in the sub control unit of the gaming machine in an embodiment of the present invention;

FIGS. 7A and 7B are explanatory drawings that explain one example of an image displayed on a reel portion display of the gaming machine in an embodiment of the present invention;

FIG. 8 is a flow chart that shows the flow of alarm time determination processing which is performed in the sub control unit of the gaming machine in an embodiment of the present invention;

FIGS. 9A to 9E are explanatory drawings which explain one example of an image displayed on a reel portion display of the gaming machine in an embodiment of the present invention; and

FIG. 10 is a flow chart that shows the flow of intermission period determination processing which is performed in the sub control unit of the gaming machine in an embodiment of the present invention.

### DESCRIPTION OF THE PREFERRED EMBODIMENTS

Below a preferred embodiment of the present invention is explained in reference to the drawings in which as an example the gaming machine is a slot machine.

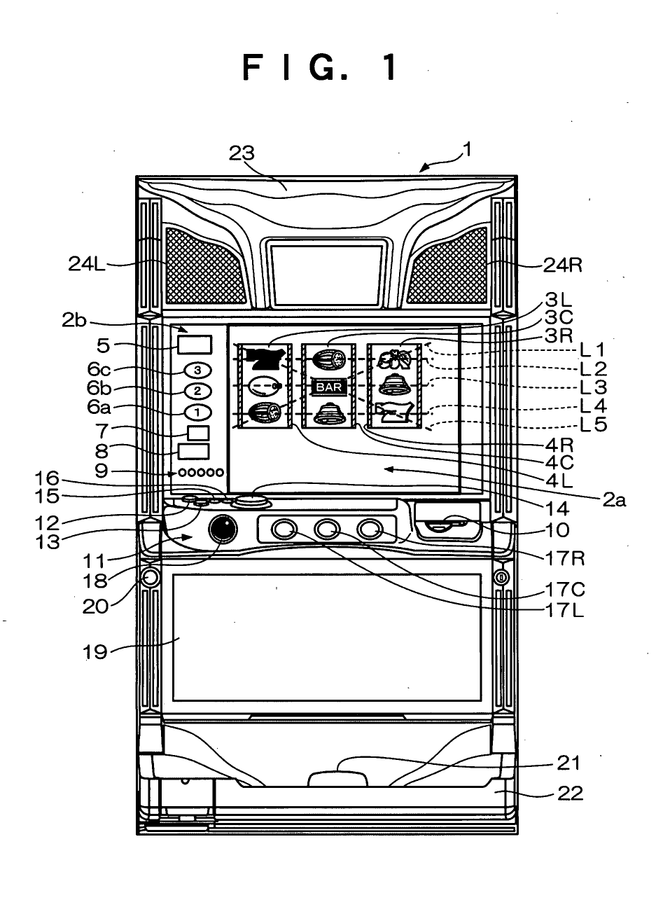

FIG. 1 is a front surface view of a gaming machine 1 relating to an embodiment of the present invention. Three reels 3L, 3C and 3R are provided rotatably in a horizontal row in the inner portion of the gaming machine 1. Symbol columns constructed of a plurality of types of symbols are drawn respectively on the circumference circles of the reels 3L, 3C and 3R. These reels are disposed in visible locations, placed in reel display windows 4L, 4C and 4R which are formed in a reel portion display 2a (the portion enclosed with the thick line in FIG. 1) which is located substantially in the center of the front surface of the gaming machine 1, and these reels are structured so that three symbols are visible, on an upper row, a middle row and a lower row, respectively, from each of the reel display windows in a stopped condition of reels before and after a game.

Also pay lines are predetermined in the gaming machine 1 which act as a reference for determining whether or not winning or the like is achieved on the basis of the symbols displayed in the reel display windows 4L, 4C and 4R when the rotation of the three reels is stopped. Oblique line rising to the right L1, upper row line L2, middle row line L3, lower row line L4 and oblique line falling to the right L5 are provided as pay lines. Active pay lines, more specifically, active lines vary according to the number of inputted medals. Insertion of medals is performed by inserting medals into a medal insertion slot 10 to be described below, and the number of medals that can be inserted for one game is a maximum of three. Also, pay lines are activated according to the number of the inserted medals, for example when one medal is inserted there is one pay line (middle row line L3), when two medals are inserted there are three pay lines (upper row line L2 and lower row line L4 are added), and when three medals are inserted there are five pay lines (oblique line L1 and falling to the right line L5 are further added).

The reel portion display 2a is a normally white liquid crystal image display device. The reel display windows 4L, 4C and 4R, which correspond to the three reels 3L, 3C and 3R on the inner portion thereof, are displayed on the screen of the reel portion display 2a during a game. The player can view these reels on the inner portion through these reel display windows. Also, images that increase a sense of expectation or interest in the game, and various information that are of value to the player when the game is played, are displayed on a display area outside of the reel display windows 4L, 4C and 4R. Note that a detailed explanation of the structure of the reel portion display 2a is omitted due to it being the same as conventional structures.

A reel portion panel 2b is disposed on the left side of the reel portion display 2a. A bonus count display unit 5, BET lamps 6a to 6c, a payout number display unit 7, an accumulated number display unit 8 and a gaming state display lamp group 9 are disposed in order from the top of the drawing in the reel portion panel 2b. The bonus count display unit 5 is formed from three digits of seven-segment displays, and displays the number of medals to be paid out by the gaming machine 1 during a bonus game. The BET lamps 6a, 6b and 6c show the number of medals inserted for one game by the number of lit lamps, in that when one medal is inserted only the BET lamp 6a is lit, when two medals are inserted the BET lamps 6a and 6b are lit, and when three medals are inserted the BET lamps 6a, 6b and 6c are lit. The payout number display unit 7 is formed from two digits of seven-segment displays, and displays the number of medals to be paid out when there is a winning result in the game. The accumulated number display unit 8 is formed from three digits of seven-segment displays, and shows the number of medals accumulated in the gaming machine 1.

The gaming state display lamp group 9 is formed from five LEDs. An insert lamp IN, a start lamp ST, a wait display lamp WA, a repeat display lamp RE, and a winning display lamp WN are disposed in order from the left in the figure. Also, lit conditions of each of these LEDs report current gaming states to the player. Here the insert lamp IN shows by being lit that a condition exists in which a medal can be inserted. The start lamp ST shows by being lit that a condition exists in which start of game (operation of the start switch to be described below) is possible. The wait display lamp WA shows by being lit that a condition exists in which the start of rotation of the reels 3L, 3C and 3R is on standby even if the start switch is operated because 4.1 seconds have not passed since the start of the previous game. In this case, when 4.1 seconds pass from the start of the previous game, the wait display lamp WA is turned off and the reels 3L, 3C and 3R start to rotate. The repeat display lamp RE shows by being lit that the next game to start is a repeat game. The winning display lamp WN shows by being lit that in an internal lottery to be described below, a bonus combination was formed.

The medal insertion slot 10 is provided on the lower side of the reel portion display 2a and the reel portion panel 2b, on the right side of the front surface of the gaming machine 1. The previously described active pay lines are determined according to the number of medals inserted into the medal insertion slot 10. Also, after three medals have been inserted and then more medals are inserted, the fourth inserted medal and beyond are accumulated inside the gaming machine 1. The gaming machine in the present embodiment can accumulate a maximum of 50 medals. A pedestal portion 11 is formed on the lower side of the reel portion display 2a and the reel portion panel 2b, to the left side of the substantial center of the front surface of the gaming machine 1.

The 2-BET switch 12, 1-BET switch 13 and MAX-BET switch 14 are provided in order from the left in FIG. 1 on the left side of the upper surface of the pedestal portion 11. Each of these BET switches is for inserting medals from the medals accumulated in the gaming machine 1. In a condition in which three or more medals are accumulated in the gaming machine 1, every time the 1-BET switch 13 is operated one medal at a time is inserted from the accumulated medals, when the 2-BET switch 12 is operated two medals at a time are inserted from the accumulated medals, and when the MAX-BET switch 14 is operated three medals at a time are inserted into the gaming machine 1 from the accumulated medals. By operating each type of BET switches 12 to 14 in this manner, medals are inserted into the gaming machine 1 in the same manner as the case in which the medals are inserted into the medal insertion port 10, and previously described active pay lines are determined according to the number of inserted medals. Also, a selection button 15 and a determination button 16 are provided to perform various types of settings relating to an alarm time and an intermission period to be described below, being provided between the 1-BET switch 13 and the MAX-BET switch 14. The operating contents of these switches will be described below.

Stop switches 17L, 17C and 17R, which are corresponded to each reel display windows 4L, 4C and 4R, respectively, are disposed below these reel display windows on a perpendicular surface of the pedestal portion 11 and substantially in the center of the front surface of the gaming machine 1. The stop switches 17L, 17C and 17R correspond to the reels 3L, 3C and 3R, respectively, and for example, when the stop switch 17L is pushed, a main control unit to be described below performs stop control on the left reel 3L. In the same manner, when the stop switch 17C is pushed, stop control is performed on the center reel 3C, and when the stop switch 17R is pushed, stop control is performed on the right reel 3R. The start switch 18 is provided, on the left side of the stop switches 17L, 17C and 17R, which, when the player pushes down the start switch 18, causes the three reels to rotate and to start variation of the symbols displayed on the reel display windows 4L, 4C and 4R.

A lower panel 19 is disposed on the lower side of the pedestal portion 11. The name of the gaming machine 1 or pictures of characters or the like that pertain to the concept of the gaming machine 1 are drawn on the lower panel 19. A medal payout switch 20 is provided, on the left side of the lower panel 19, to pay out medals that have accumulated in the gaming machine 1. A medal payout opening 21 is provided on the lower side of the lower panel 19. Medals are paid out from the medal payout opening 21 when the result of game performed on the gaming machine 1 is a win, and in the case in which the medal payout switch 20 is pressed when medals are accumulated in the gaming machine 1, and these medals accumulate in a medal tray 22. An upper portion lamp 23 is provided, on the uppermost portion of the gaming machine 1, which is lit with a lighting symbol according to gaming states to perform effects or indication. Also, a right speaker 24R and a left speaker 24L are disposed on the lower side of the upper portion lamp 23 to output operation sounds, effect sounds, indication sounds or the like according to the gaming states.

Next an explanation will be given of the structure of a control unit, which performs control relating to the game of the gaming machine 1 in reference to FIG. 2. The control unit in the gaming machine 1 is structured with a main control unit 30 and a sub control unit 60. The main control unit 30 mainly performs control relating to the game performed on the gaming machine 1, such as insertion of medals, rotation and stopping of the reels and payout of medals. The sub control unit 60 mainly performs control relating to effects of sound, light, images and the like carried out along with the game.

The main control unit 30 has as a main structural component a microcomputer 31 disposed on a circuit board and, in addition, has a circuit for random number sampling. The microcomputer 31 includes a main CPU 32 to perform control operations in accordance with a predetermined program, and program ROM 33 and control RAM 34 which are storage means. Connected to the main CPU 32 are a clock pulse generating circuit 35 which generates a reference clock pulse, a frequency divider 36 which divides the frequency of the reference clock pulse, a random number generator 37 which generates random numbers in a predetermined range of numerical values (for example 0 to 16383), and a sampling circuit 38 which samples the generated random numbers. Also the main CPU 32 performs exchange of signals with each type of input/output device to be described below via an I/O port 39. Note that random numbers sampling is carried out by the operating program of the main CPU 32. In that case it is possible to omit the random number generator 37 and the sampling circuit 38, however, it is also possible to leave them as a backup to the random numbers sampling operation.

The main CPU 32 performs processing on the basis of the reference clock pulse generated by the clock pulse generating circuit 35, and interrupt processing and the like is performed at fixed times on the basis of the pulse signal generated by the frequency divider 36. In addition to the program which performs game control in the gaming machine 1, a symbol table, a plurality of probability lottery tables, a stop table group, a winning determination table, and the like are stored in the program ROM 33 of the microcomputer 31.

Here the symbol table is one, in which each step of stepping motors which correspond respectively to the reels 3L, 3C and 3R, corresponds to symbols types thereof drawn respectively on the reels 3L, 3C and 3R. The main control unit 30 performs stop control of each reel and identifying of the symbols displayed in the reel display windows 4L, 4C and 4R when stopped, in reference to the symbol table.

The probability lottery tables are set in correspondence with each numerical value and each combination type in the range of numerical values of the random numbers generated by the random number generator 37, and are referred to when the internal lottery is performed on the basis of the result on the random numbers sampling performed by the previously described sampling circuit 38.

The types of combinations determined in the internal lottery can roughly be divided into winning combinations, replay combinations and losing combinations. A winning combination is one in which an award is provided to the player, and according to the contents of the award provided a plurality of types of winning combinations exist. For example, a small combination is a winning combination in which a predetermined number of medals is paid out to the player, while a BB combination and an RB combination (taken together, these constitute bonus combinations) are combinations in which, as the next game, a BB game or an RB game is started, respectively. A replay combination is a combination in which the next game is a replay, and a loss is a combination that is neither a winning nor a replay combination, and is a combination in which no award is provided to the player.

Also the probability lottery tables are prepared as a plurality of tables in which the winning probabilities of each combination described above is different, and a unique number is applied to each probability lottery table. A staff member of the game arcade can set which probability lottery table number is used when the internal lottery is performed.

The stop table group is formed from a plurality of stop tables which depend on the results of the internal lottery and the reels which are the object of the stop control, and each stop table matches each symbol on the reel to information which shows whether or not a symbol can be stopped at a predetermined position (for example the lower row) in the reel display windows. These stop tables are referred to when stop control is performed on the reels in accordance with the operation of the stop switches 17L, 17C and 17R.

In the winning determination table is set the previously described combinations of symbols in which each type of winning or replay combination are formed and the number of medals to be paid out corresponding to combinations of each type of symbol in which a winning combination is formed. This winning determination table is referred to when winning determination is performed after all the reels stop.

In the control RAM 34 various types of information are stored which are generated in processes performed by the main CPU 32. For example, information is set concerning setting values which set the probability lottery table which is referenced when the internal lottery is performed, concerning an internal lottery combination, concerning each type of gaming state and the like. This information is transmitted to the sub control unit 60 via a sub control unit communication port 40. The exchange of each type of information transmitted from the main control unit 30 to the sub control unit 60 is performed in one direction from the main control unit 30 to the sub control unit 60, and is no information is transmitted from the sub control unit 60 to the main control unit 30.

Examples of information transmitted from the main control unit 30 to the sub control unit 60 include information which shows that the start switch 18 has been operated and that game has started, and which shows the number of metals inserted for the game (game start information), information which relates to the result of the internal lottery, whether any of the winning combinations is won and in the case of a winning combination, the type of the combination (internal lottery information), information which relates to the current game type (basic game, bonus flag carry-over, RB game, BB game, and the like) (game type information), information which shows which stop switch is operated (stop operation information), information which shows the result of a winning determination, and the active pay line when a symbol combination that corresponds to a winning combination or a replay combination lines up (winning determination information), and the like.

Each type of display device provided in the reel portion panel 2b (refer to FIG. 1), a hopper 50 for paying out medals (including a drive unit to pay out medals), and stepping motors 25L, 25C and 25R to rotatably drive the reels 3L, 3C and 3R are provided as main output devices, shown in the block diagram of FIG. 2, whose operation is controlled by the microcomputer 31. The microcomputer 31, via each lamp drive circuit 41, drives and controls each LED which constitutes the BET lamps 6a, 6b and 6c, and the gaming state display lamps group 9, all of which are provided on the reel portion panel 2b. Also the microcomputer 31, via each display unit drive circuit 42, drives and controls each seven-segment display devices of the bonus count display unit 5, the payout number display unit 7 and the accumulated number display unit 8. The microcomputer 31 further drives and controls the hopper 50 via a hopper drive circuit 43 and drives and controls the stepping motors 25L, 25C and 25R via a motor drive circuit 44. Each type of drive circuit described above are connected to the main CPU 32 via the I/O port 39, receive respective control signals such as a drive command from the main CPU 32, and control the operation of respective corresponding output devices.

A medal insertion switch 10S which detects a medal inserted from the medal insertion slot 10, the BET switches 12 to 14, the stop switches 17L, 17C and 17R, the start switch 18, the medal payout switch 20 are types of switches provided as main input devices which generate the necessary input signals to cause the microcomputer 31 to generate a control command. Each of the signals which are output from these types of switches are output to the main CPU 32 via the I/O port 39. Note that in the cases of the stop switches 17L, 17C and 17R, a stop signal which corresponds to the stop switch pushed by the player is output from a reel stop signal circuit 51 to the main CPU 32 via the I/O port 39.

In addition to the types of switches described above, signals are also input to the main CPU 32 from photo couplers (not shown in the diagrams) provided corresponding to each reel 3L, 3C and 3R, and from a medal detection unit 52 which detects medals paid out from the hopper 50. Each photo coupler is connected to a reel position detection circuit 45 in the main control unit 30, and a reference position signal which corresponds to the respective reel is output from the reel position detection circuits 45 and transmitted to the main CPU 32 via the I/O port 39 when a reference position, provided in each corresponding reel, is detected.

Also, the medal detection unit 52 outputs a detection signal each time one medal is paid out from the hopper 50, to a payout signal generation circuit 46 in the main control unit 30. The payout signal generation circuit 46 outputs the detection signal outputted from the medal detection unit 52 to the main CPU 32 via the I/O port 39.

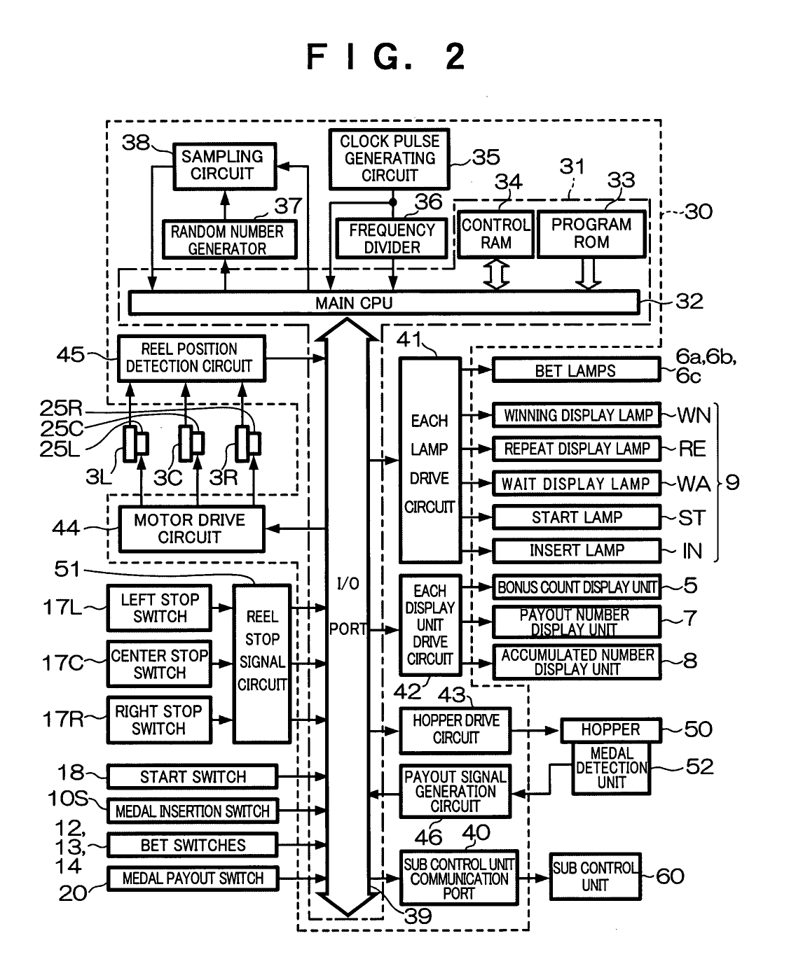

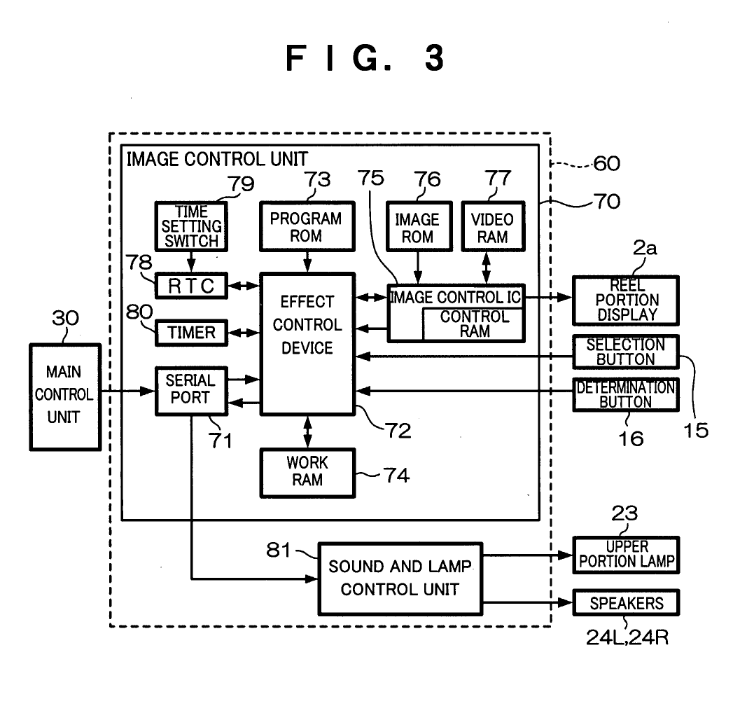

Next, the structure of the sub control unit 60 will be explained in reference to FIG. 3. The sub control unit 60 is provided with an image control unit 70, and a sound and lamp control unit 81. The image control unit 70 and the sound and lamp control unit 81 are provided on separate circuit boards from the circuit board, which constitutes the main control unit 30. Also, communication between the image control unit 70 and the sound and lamp control unit 81 is performed in one direction from the image control unit 70 to the sound and lamp control unit 81, and no information is transmitted from the sound and lamp control unit 81 to the image control unit 70.

The image control unit 70 is provided with a serial port 71, an effect control device 72, program ROM 73, work RAM 74, an image control IC 75, image ROM 76, video RAM 77, a real time clock 78, a time setting switch 79 and a timer 80. The serial port 71 receives each type of information transmitted from the main control unit 30. The effect control device 72 comprises a CPU, an interrupt controller, an input/output port, and a timer, and performs control of effects of images, sounds and lights, setting of an alarm time and an intermission period to be described below, indicating control relating to this control and setting, and the like in accordance with a control program stored in the program ROM 73.

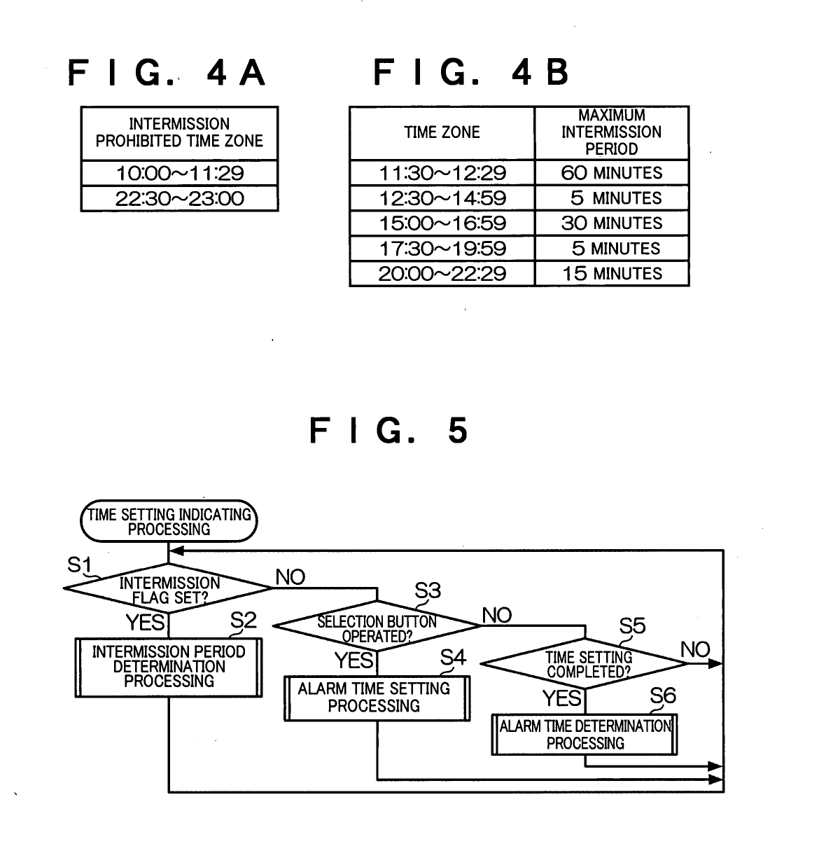

The program ROM 73 stores the control program which is executed by the CPU in the effect control device 72, each type of effect determination table, each type of data referred to when the player sets an intermission period, and the like. Here the effect determination tables are set to correspond to each random number generated by the CPU of the effect control device 72 and to the contents of each type of effect, and store a plurality of tables that correspond to the result of the internal lottery in the main control unit 30 and to the current game type. The various types of data referred to when the player sets an intermission period, as shown in FIGS. 4A and 4B, include data such as that which corresponds to time zones in which an intermission period cannot be set (termed intermission prohibited time zones below), and that which corresponds to each time zone and time period in which an intermission is possible (termed intermission period list below). In gaming machine 1, 10:00 to 11:29, and 22:30 to 23:00 are set in advance as intermission prohibited time zones (refer to FIG. 4A). Also, 11:30 to 12:29, with a maximum intermission period of 60 minutes, 12:30 to 14:49, with a maximum intermission period of five minutes, 15:00 to 16:59, with a maximum intermission period of 30 minutes, 17:00 to 19:59, with a maximum intermission period of five minutes, and 20:00 to 22:29, with a maximum intermission period of 15 minutes, are set in advance as the contents of an intermission period list (refer to FIG. 4B). The work RAM 74 stores in respective storage areas set in advance, the various types of information received by the effect control device 72 from the main control unit 30, the various types of data described above, generated when the control program is executed, data relating to an alarm time and to an intermission period inputted with the selection button 15 and the determination button 16 (to be described in detail below), which are input means for the time and the time period, and the like. Also an intermission flag (initial value of “0”) is included in the data relating to an intermission period described above, in which the intermission flag shows whether the gaming machine 1 is currently in an intermission state. Hence, the work RAM 74 corresponds to time storage means, which stores times, and corresponds to time period storage means, which stores input lengths of times.

The image control IC 75 comprises internal control RAM in which the effect control device 72 performs letters and reading of each type of information, produces actual image data to display on the reel portion display 2a in accordance with a command from the effect control device 72, using image data written to the control RAM or image data stored in the image ROM 76 to be described below, and writes the actual image data in the video RAM 77. Then the image data written in the video RAM 77 is transmitted to the reel portion display 2a and display of an image is performed on the basis of this image data. The image ROM 76 stores image data or dot data to produce effect images and images for advertising, image data for setting and indicating an alarm time and an intermission period, and the like. For example the image ROM 76 stores sprite image data of characters that are human, animal and the like, symbols, letters, diagrams and the like, background image data which includes a white rectangular area which forms the reel display windows 4L, 4C and 4R, and the like. Here images for advertising are images with no relation to the game and are for example so-called demo images using a logo of the gaming machine maker, a character that fits the concept of the gaming machine 1, or the like, or images which show event information for the game arcade in which the gaming machine 1 is installed. Also, the sprite image data is of images that are displayed superimposed on the background image (background surface).

The video RAM 77 is used as temporary storage means when data is produced for an image which the image control IC 75 will display on the reel portion display 2a. Also, the image control IC 75 transmits a signal to the effect control device 72 each time data in the video RAM 77 in transferred to the reel portion display 2a. The real time clock (termed RTC below) 78 continually measures the current year, month, day, hour, minute and second (termed collectively as current time information below), and outputs this current time information to the effect control device 72 in response to a request from the effect control device 72. Also the RTC 78 has an internal battery, and performs time-measuring powered by a power source supplied to the gaming machine 1 when the power source of the gaming machine 1 is turned on, and performs time-measuring powered by the internal battery when the power source of the gaming machine 1 is turned off. Hence the RTC 78 corresponds to time measuring means, which measures the current time powered by an internal power source.

The time setting switch 79 is a switch that sets or corrects the current time in the RTC 78, is provided inside the cabinet of the gaming machine 1, and is operated by staff members of the game arcade. The time setting switch 79 is used when correcting the time set in the RTC 78 at the time the gaming machine 1 is shipped or when correcting time-measuring errors in the RTC 78. The timer 80, when the effect control device 72 sets an intermission period which is stored in the work RAM 74, measures the time period, and outputs the remaining time period of the set time period to the effect control device 72 in response to a request from the effect control device 72. Hence, the timer 80 corresponds to time measuring means, which measure a time period stored in the time period storage means (work RAM 74). The sound and lamp control unit 81 controls turning on and off the upper portion lamp 23 on the basis of commands from the image control unit 70 and generates and controls sound output from the speakers 24L and 24R.

Next, the content of the game control performed by the main control unit 30 and the sub control unit 60 described above will be explained. Before the start of game the microcomputer 31 turns on the insert lamp IN of the gaming state display lamp group 9 via the respective lamp drive circuit 41. Then when a player inserts a medal into the medal insertion slot 10 and the BET switches 12 to 14 are operated, the microcomputer 31 turns off the insert lamp described above and turns on the BET lamps 6a, 6b or 6c in accordance with the number of inserted medals, via each of the respective lamp drive circuits 41. Also, when the insertion operation of the medals is performed in accordance with the BET switches 12 to 14, the microcomputer 31 turns on the appropriate BET lamp 6a, 6b, or 6c described above and updates the count value displayed on the accumulated number display unit 8 by subtracting the inserted number of medals.

Then the microcomputer 31 turns on the start lamp ST from among the gaming state display lamp group 9 to show a condition in which start of game is possible and to prompt the player to operate the start switch 18. Also the game type information described above is transmitted to the sub control unit 60 via the sub control unit communication port 40. The sub control unit 60 writes the received game type information to the work RAM 74.

Afterwards, when the main CPU 32 detects the operation of the start switch 18 by the player, the microcomputer 31 starts one game. More specifically, the microcomputer 31 turns off the start lamp ST among the gaming state display lamp group 9 and rotates the reels 3L, 3C and 3R by driving the stepping motors 25L, 25C and 25R via the motor drive circuit 44. Also the microcomputer 31 samples the random numbers generated by the random number generator 37 with the sampling circuit 38, and performs an internal lottery on the basis of the sampled random numbers and the probability lottery tables stored in the program ROM 33, to determine the combinations in the game. Then the microcomputer 31 transmits the game start information and the internal lottery information to the sub control unit 60 via the sub control unit communication port 40.

Effect lottery processing is performed in the sub control unit 60 when the effect control device 72 receives the game start information and internal lottery information via the serial port 71. More specifically, the sub control unit 60 causes random number values to be generated, selects an effect determination table on the basis of the internal lottery information and the previously received game type information and determines the type of effect in accordance with the generated random number values in reference to the selected effect determination table. The sub control unit 60 outputs a command to the screen control IC 75 for an image to be generated in accordance with the type of the determined effect. Then the image control IC 75 reads the appropriate image data from the image ROM 76 on the basis of commands from the effect control device 72, and produces the image data to be displayed on the reel portion display 2a, writing the image data to the video RAM 77. Then the image control IC 75 displays the image data written to the video RAM 77 in the effect display area on the reel portion display 2a.

Also the effect control device 72 transmits a command that corresponds to the effect determined in the effect lottery to the sound and lamp control unit 81 via the serial port 71. The sound and lamp control unit 81 which receives this command performs control to turn on and turn off the upper portion lamp 23, generates and controls so-called start sounds output from the speakers 24L and 24R, and the like in accordance with this command.

The microcomputer 31 counts the number of drive pulses supplied to each of the stepping motors 25L, 25C and 25R when the reels 3L, 3C and 3R are rotated, and stores these counted values successively in a predetermined area of the control RAM 34. Then each time the photo couplers provided corresponding to each reel detect the reference position that accompanies each rotation of a reel, the reference position signal of each reel is output from the reel position detection circuit 45. When these reference position signals are input in the microcomputer 31 the count values of the drive pulses stored in the control RAM 34 are cleared to zero. In this manner a count value is set corresponding to a rotation position in the range of one rotation of each reel, in the control RAM 34. The microcomputer 31 determines the symbol that is displayed in the reel display windows 4L, 4C and 4R on the basis of the count value and the symbol table stored in the program ROM 33.

When the player operates one of the stop switches 17L, 17C or 17R, a stop signal which corresponds to the operated stop switch is output to the microcomputer 31 from the reel stop signal circuit 51. Thus the microcomputer 31 transmits stop operation information to the sub control unit 60 via the sub control unit communication port 40 and, on the basis of a stop control table stored in the program ROM 33, performs stop control on the reel which corresponds to the operated stop switch. This stop control, when the result of the internal lottery is a replay combination or any winning combination, performs stop display so the symbol combination which corresponds to this winning combination aligns with the active pay line as much as possible. Also, when the result of the internal lottery is a loss, stop control is performed so that a symbol combination which corresponds to a winning combination is not arranged on an active pay line, even if the player operates the stop switches 17L, 17C and 17R at a timing in which a symbol combination which corresponds to a replay combination or any winning combination would be arranged on an active pay line.

When a reel stops as a result of stop control on the reel, the microcomputer 31 transmits symbol types (stopped symbol information) to be stopped and displayed on the respective upper row, middle row and lower row of the reel display window which corresponds to the stopped reel, to the sub control unit 60 via the sub control unit communication port 40. Thus the sub control unit 60, on the basis of the received operation information and stopped symbol information, causes an effect sound to be generated at the timing in which the stop switch is operated, and executes various effects by displaying effect images and the like in the effect display area of the real portion display 2a to increase the excitement in the game, in accordance with the symbol stopped and displayed in the reel display window.

Then when all the reels stop, the microcomputer 31 performs winning determination in reference to the winning determination table stored in the program ROM 33. More specifically, the microcomputer 31 determines whether there is a symbol combination arranged on an active pay line that corresponds to a winning symbol combination or a replay combination, and transmits the winning determination information to the sub control unit 60. When as a result a winning symbol combination is arranged on an active pay line, the microcomputer 31 drives the hopper 50 via the hopper drive circuit 43, and displays the number of medals to be paid out corresponding to the winning symbol combination on the payout number display unit 7 via each display unit drive circuit 42. Then, when the frequency of the payout signal output from the payout signal generation circuit 46 matches the number of medals to be paid out for the winning combination stored in the winning determination table, the payout of medals by the hopper 50 is stopped and the insert lamp IN is caused to blink.

On the other hand, when the sub control unit 60 recognizes that a bonus combination has been won through received winning determination information, the sub control unit 60 transmits an image control command and a sound and light control command to display a message and to generate a sound effect which congratulates the player, to the image control IC 75 and the sound and lamp control unit 81. Then the image control IC 75 and the sound and lamp control unit 81 which receive these commands display the respective images according to these commands in the effect display area of the reel portion display 2a, and perform light control of the upper portion lamp 23 and generation and control of the sound effects output from the speakers 24L and 24R.

Also, when the result of the winning determination is a symbol combination which corresponds to a replay combination, the sub control unit 60 ends the game and turns on the replay display lamp among the gaming state display lamp group 9, and then turns on one of the BET lamps 6a, 6b or 6c according to the number of medals inserted for the game and turns on the start lamp ST among the gaming state display lamp group 9. Furthermore, when the result of the winning determination is a loss, the sub control unit 60 ends the game and turns on the insert lamp IN, among the gaming state display lamp group 9, which shows that start of the next game is possible.

As shown above, the sub control unit 60 performs control relating to the game in the gaming machine 1, and through control of the effect control device 72 various types of effect images corresponding to this game are displayed on the reel portion display 2a.

Also, in the gaming machine 1, alarm indicating is performed at a time set by the player using the selection button 15 and the determination button 16, and when the player steps away from the gaming machine 1, it is possible to secure the gaming machine 1 so that other players cannot play the gaming machine for only the predetermined time period. The time period that the gaming machine 1 can be secured is termed the intermission period below.

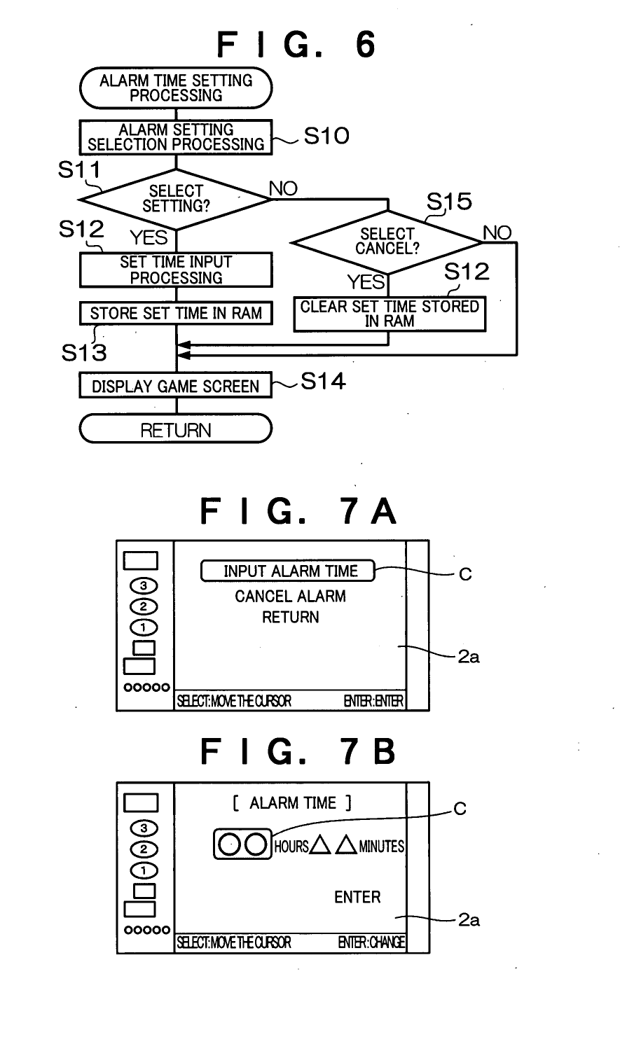

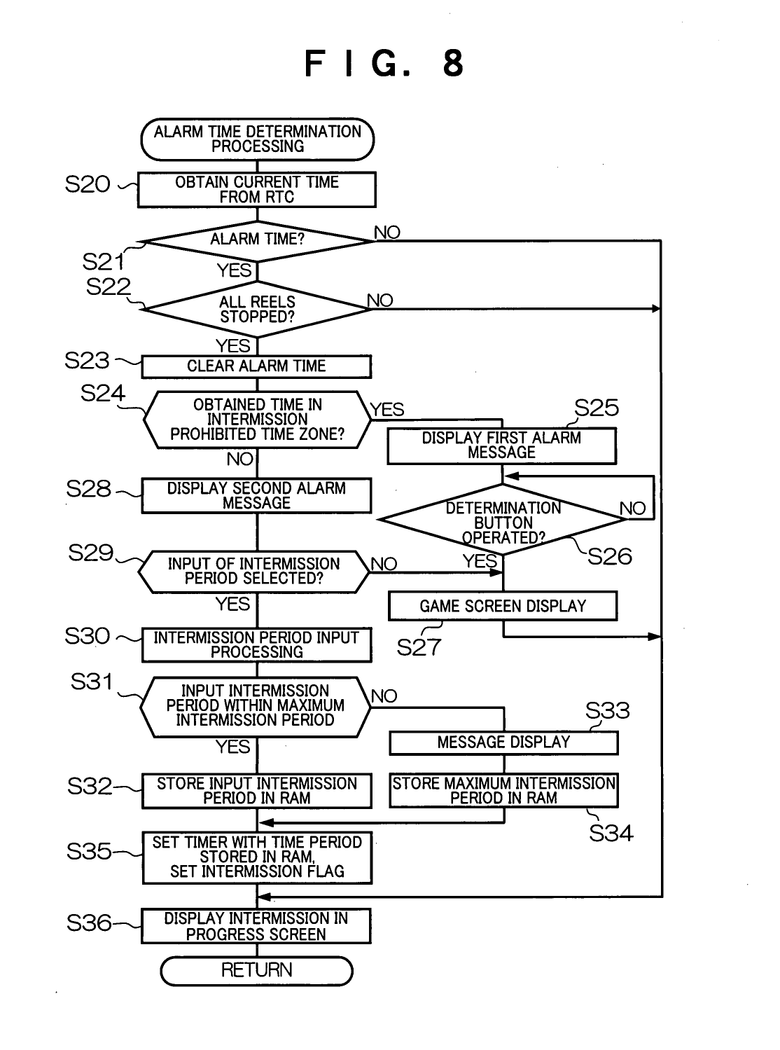

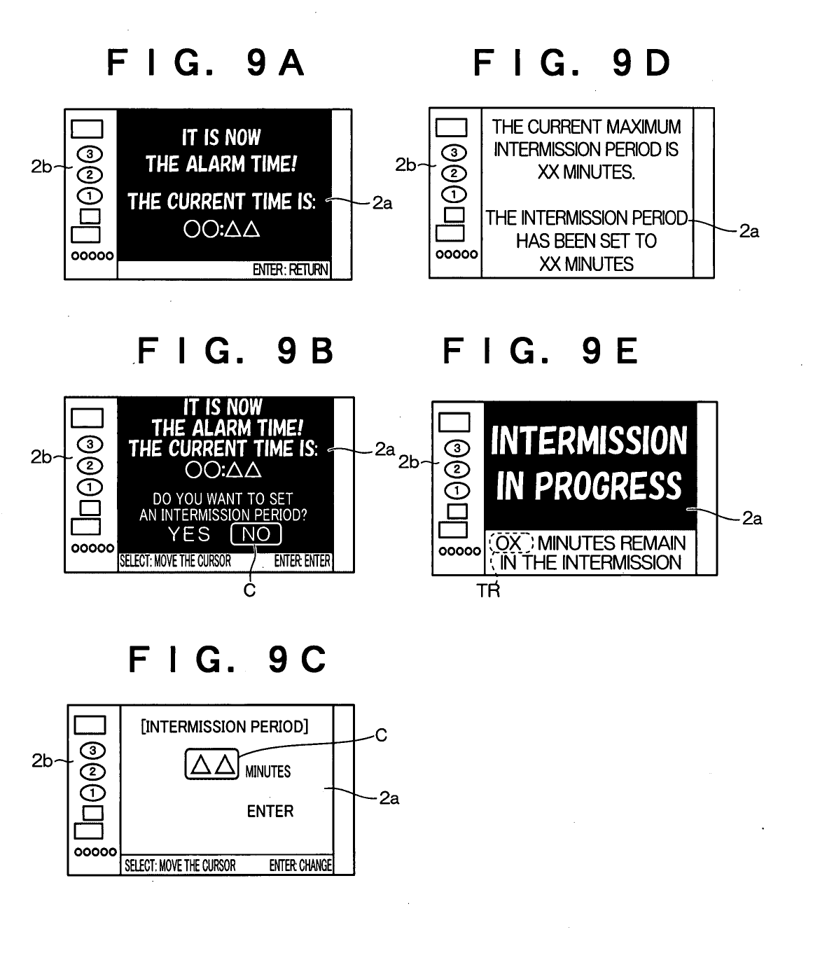

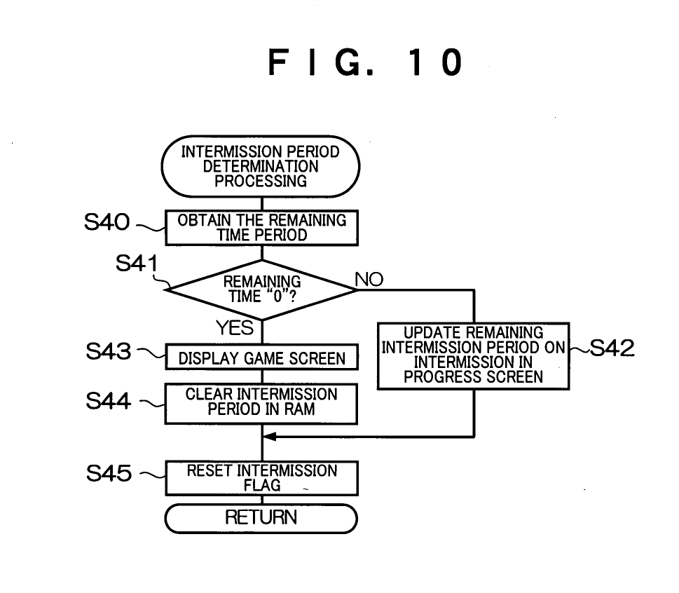

Below the contents of the control necessary to implement these functions will be explained in reference to the flowcharts shown in FIGS. 5, 6, 8 and 10 and to the display contents of the reel portion display 2a shown in FIGS. 7A and 7B, and 9A to 9E. Here, FIG. 5 is a flow chart that shows the flow of time setting indicating processing which performs setting, indicating and the like of the alarm time and the intermission period described above. FIG. 6 is a flowchart that shows the detailed contents of alarm time setting processing in the time setting indicating processing described above. FIG. 8 is a flowchart that shows the detailed contents of the alarm time setting processing in the time setting indicating processing described above. FIG. 10 is a flowchart that shows the detailed contents of intermission period determination processing in the time setting indicating processing described above. Also FIGS. 7A and 7B are diagrams which show the contents relating to an alarm time setting screen, which is shown on the reel portion display 2a, in the alarm time setting processing shown in FIG. 6. FIGS. 9A to 9E are diagrams that show the contents of an alarm indicating screen, an intermission period setting screen for setting an intermission period, and an intermission screen which is displayed during intermission, which are shown on the reel portion display 2a, in the alarm time setting processing shown in FIG. 8. Note that the time setting indicating processing shown in FIG. 5 is executed, performing time-sharing with the effect control processing which relates to the game, performed in the effect control device 72.

When the effect control device 72 starts the time setting indicating processing shown in FIG. 5, the effect control device 72 first determines whether the intermission flag stored in a predetermined storage area of the work RAM 74 is set (more specifically, determines whether the intermission flag value is “1”) (step S1). When the intermission flag is set the determination result is “YES”, and the effect control device 72 performs intermission period determination processing to determine whether the intermission period set by the player has ended (step S2). Here, when it is determined that the intermission period is finished, the intermission flag is reset (more specifically, the intermission flag value is set to “0”). Then when the intermission period determination processing in step S2 is ended, the process returns to step S1. Also when the intermission flag is reset in step S1 and the determination result is NO, the effect control device 72 determines whether the selection button 15 has been operated (step S3). When a determination that the selection button 15 has been operated is made, the determination result is YES and the effect control device 72 performs alarm time setting processing to store the alarm time set by the player in the work RAM 74 (step S4). Then when the alarm time setting processing is ended the process returns to step S1. On the other hand, when a determination that the selection button 15 has not been operated is made in step S3, the determination result is NO and the effect control device 72 determines whether an alarm time is set (step S5). This determination is performed on the basis of whether an alarm time set by the player is stored in the predetermined storage area of the work RAM 74. When an alarm time is set, the determination result is YES, and the effect control device 72 determines whether the alarm time set by the player has arrived, and when the alarm time has arrived, the effect control device 72 performs alarm time determination processing to set an intermission period in accordance with a request of the player (step S6). At this time, if an intermission period is set by the player, the intermission flag is set. When the alarm time determination processing is ended, the process returns to step S1. Also, when a determination that an alarm time has not been set is made in step S5, the determination result is NO and the effect control device 72 returns to step S1 without any further action.

In this manner the effect control device 72 checks, in order, the condition of the intermission flag, whether the selection button 15 is operated not and whether an alarm time is set or not (step S1 then step S3 then step S5), and in accordance with the results of check, performs intermission period determination processing (step S2), alarm time setting processing (step S4) and alarm time determination processing (step S6). Note that after when the intermission flag is set in the alarm time determination processing of step S6, the processing in steps S1 and S2 is repeatedly performed until the intermission flag is reset in the intermission period determination processing of step S2, thus during this period, even if the selection button 15 is operated, the alarm time setting processing of step S4 is not performed.

Next, an explanation will be given of the content of the alarm time setting processing of step S4 in the time setting indicating processing shown in FIG. 5 with reference to FIGS. 6, 7A and 7B. When a determination is made that the selection button 15 has been operated by the player in step S3 of FIG. 5, the effect control device 72 executes the alarm time setting processing shown in FIG. 6. First the effect control device 72 performs alarm setting selection processing with the image control IC 75 (step S10). More specifically, first an alarm setting selection screen shown in FIG. 7A is displayed on the reel portion display 2a. Three items (letters) are displayed on this alarm setting selection screen, “input alarm time”, “cancel alarm” and “return”, and a cursor C is displayed which encloses one of these items. Note that FIG. 7A shows a condition in which the cursor C is displayed around the position of “input alarm time”. The effect control device 72 moves the display position of the cursor C in order to the next item, each time the selection button 15 is operated, and performs this processing until the determination button 16 is operated. When the determination button 16 is operated, the effect control device 72 takes the item indicated by the cursor C as the selection of the player and ends the alarm setting selection processing of step S10, and continues down the process.

More specifically, when the cursor C is displayed at the “input alarm time” position, if the determination button 16 is operated, the determination result in step S11 is YES, and the effect control device 72 performs set time input processing (step S12). More specifically, the effect control device 72, first displays an alarm time input screen shown in FIG. 7B on the reel portion display 2a with the image control IC 75. This alarm time input screen displays numbers that indicate the hours portion of the alarm time (the portion indicated by “OO” in the figure), numbers that indicate the minutes portion of the alarm time (the portion indicated by “ΔΔ” in the figure), and “enter”. These numbers and letters are selectable with a cursor C, and each time the selection button 15 is operated the cursor C moves in order among the positions of the numbers that show the hours portion and the minutes portion of the alarm time, and the letters “enter”. When the determination button 16 is operated in a condition in which the cursor C is indicated in a position of the numbers which show the hours or minutes portion, the hours or minutes portion of the alarm time shown on the alarm time input screen advances by one hour or one minute respectively for each time the determination button 16 is operated. Also when the determination button 16 is operated in a condition in which the cursor C is indicated in a position of the item “enter”, the effect control device 72 recognizes the currently entered alarm time as the alarm time input by the player. Hence, the selection button 15 and the determination button 16 correspond to time input means to input time from outside the cabinet of the gaming machine 1. The effect control device 72 stores the input alarm time in the predetermined area of the work RAM 74 (step S13), displays once more the game screen that was displayed before the alarm setting selection screen was displayed in step S10, on the reel portion display 2a with the image control IC 75 (step S14), then returns to step S1 of FIG. 5 from the alarm time setting processing (step S4) shown in FIG. 5.

Also, in the alarm setting selection processing of step S10, when “cancel alarm” is selected from the alarm setting selection screen shown in FIG. 7A, the determination result in step S15 shown in FIG. 6 is YES, and the effect control device 72 clears the alarm time stored in the predetermined storage area of the work RAM 74 (step S16). Then the effect control device 72 moves to step S14 described above, displays once more the game screen, which was displayed before the alarm setting selection screen was displayed in step S10, on the reel portion display 2a (step S14), then returns to step S1 of FIG. 5 from the alarm time setting processing (step S4) shown in FIG. 5. Also, in the alarm setting selection processing of step S10, when “return” is selected from the alarm setting selection screen shown in FIG. 7A, the determination results of step S11 and S15 are both NO, and the effect control device 72 moves to step S14, displays once more the game screen, which was displayed before the alarm setting selection screen was displayed in step S10, on the reel portion display 2a (step S14), then returns to step S1 of FIG. 5 from the alarm time setting processing (step S4) shown in FIG. 5.

Next an explanation will be given of the contents of alarm time determination processing of step S6 in the alarm time setting indicating processing shown in FIG. 5 with reference to FIGS. 8 and 9. When the alarm time input in the alarm time setting processing in step S4 is stored in the predetermined storage area of the work RAM 74 in step S5 of FIG. 5, the determination result is YES, and the effect control device 72 executes the alarm time determination processing shown in FIG. 8. First the effect control device 72 obtains the current time from the RTC 78 (step S20). Then the effect control device 72 determines whether the current time obtained from the RTC 78 matches the alarm time stored in the work RAM 74 (step S21). When the current time and the alarm time do not match, the determination result is NO, and the effect control device 72 ends the alarm time determination processing shown in FIG. 8 and returns to step S1 of the time setting indicating processing shown in FIG. 5. On the other hand, when the current time and the alarm time match, the determination result is YES, and the effect control device 72 determines whether all of the reels 3L, 3C and 3R are stopped (step S22). Here, the effect control device 72 recognizes the period from reception of the winning determination information described above from the main control unit 30 to the reception of the game start information as an all reels stopped period.

When a determination is made that the all reels stopped period is not in effect, the determination result of step S22 is NO, and the effect control device 72 ends the alarm time determination processing shown in FIG. 8 and returns to the time setting indicating processing of step S1 in FIG. 5. On the other hand, when a determination is made that the all reels stopped period is in effect, the determination result is YES, and the effect control device 72 clears the alarm time stored in the predetermined storage area of the work RAM 74 (step S23). Then the effect control device 72 refers to the intermission prohibited time zones (refer to FIG. 4A) stored in the program ROM 73, and determines whether the current time obtained from the RTC 78 in step S20 is in the intermission prohibited time zones (step S24). When the current time is in the intermission prohibited time zones, the determination result in step S24 is YES, and the effect control device 72 displays a first alarm message shown in FIG. 9A on the reel portion display 2a with the image control IC 75 (step S25). This first alarm message is a message (the letters in FIG. 9A of “it is now the alarm time” and “the current time is”) which notifies the player that the alarm time set by the player has arrived and recognition of the display area of the reel display windows 4L, 4C and 4R is in a difficult condition to the degree that at least the symbols of the reels 3L, 3C and 3R cannot be distinguished in the reel portion display 2a. While the first alarm message is displayed, the effect control device 72 determines whether the determination button 16 is operated (step S26), and while the determination button is not operated the determination result is NO the effect control device 72 returns to the processing in step S26, enters a standby state until the determination button 16 is operated, and during this period displays the first alarm message to the reel portion display 2a.

When the determination button 16 is operated, the determination result in step S26 is YES and the effect control device 72 returns the display contents of the reel portion display 2a to the game screen that had been displayed before the first alarm message was displayed (step S27), ends the alarm time determination processing in FIG. 8 and returns to step S1 of the time setting indicating processing shown in FIG. 5. In this manner, in the gaming machine 1, when the alarm time set by the player arrives, not only is a message displayed notifying this fact, but the recognition of reel display windows 4L, 4C and 4R is in a difficult condition to a degree that the symbols of the reels 3L, 3C and 3R cannot be distinguished, and in reality a condition is set in which a game in the gaming machine 1 cannot be performed. More specifically, if for example the player ignores the first alarm message and attempts to continue game, the player cannot perform satisfactory game, thus the fact that the alarm time has arrived is even more surely conveyed to the player. Note that as a method to cause the gaming machine 1 to enter the game disable condition, one is not limited to that described above, and for example, a method may be used in which communication from the sub control unit 60 to the main control unit 30 is made possible, and in step S25 the effect control device 72 displays the first alarm message and transmits the game disable signal to the main control unit 30, and then when the determination button 16 is operated transmits the game able signal to the main control unit 30 in step S27. When the main control unit 30 receives the game disable signal, the main control unit 30 returns medals inserted from the medal insertion slot 10 to the medal tray 22 without initiating any game and performs control to make operation of each type of BET switch 12 to 14 ineffective, and then when a game able signal is received, insertion of medals from the medal insertion slot 10 or each type of BET switch 12 to 14 is permitted.

On the other hand, in step S24, when the current time obtained from the RTC 78 in step S20 is not in the intermission prohibited time zone, the determination result is NO, and the effect control device 72 displays a second alarm message shown in FIG. 9B on the reel portion display 2a with the image control IC 75 (step S28). This second alarm message is a message which notifies the player that the alarm time set by the player has arrived and a message in which a selection screen is displayed for the player to select whether to set the intermission period. More specifically, in the case of the second alarm message shown in FIG. 9B, a message, “do you want to set an intermission period ?” and the letters, “YES” and “NO” are displayed, and a cursor C is displayed which moves back and forth from the “YES” position and the “NO” position each time the player operates the selection button 15. Note that this second alarm message also, as does the previously described first alarm message (refer to FIG. 9A), causes a difficult condition to recognize the reel display windows 4L, 4C and 4R, and effectively causes a condition in which game in the gaming machine 1 is not performed. Also, FIG. 9B shows a condition in which the cursor C is indicated on the “NO” position.

In this manner, in step S21, when a determination is made that the alarm time has arrived, processing in step S25 or S28 in which the first or second alarm message is displayed on the reel portion display 2a can be said to correspond to time indicating means. Also, in the present embodiment, when the first or the second alarm message is displayed, effectively a condition in which game in the gaming machine 1 is not able to be performed is caused, thus the time indicating means can be said to include game disable means which create a game disable condition in the gaming machine 1 during the time period in which the indicating means is indicating that the alarm time (the time which was input with the input means) has arrived. Note that the first and the second alarm messages may just indicate that the alarm time has arrived to the player, and do not necessarily need to cause the recognition of reel display windows 4L, 4C and 4R being in a difficult condition to the degree that the symbols on the reels 3L, 3C and 3R are not visible. In other words, the time indicating means described above do not necessarily need to include the game disable means.

Next, the effect control device 72 determines whether one of “YES” or “NO” is selected in the display screen of the second alarm message (step S29). Thus, when the cursor C is displayed on the “NO” position, in the case that the player operates the determination button 16, the effect control device 72 recognizes that the player does not input an intermission period, sets the determination result to NO, moves to the previously described step S27, returns the display contents of the reel portion display 2a to the game screen that had been displayed before the second alarm message was displayed, and then ends the alarm time determination processing in FIG. 8 and returns to step S1 of the time setting indicating processing shown in FIG. 5.

In contrast when the cursor C is displayed on the “YES” position in the display screen of the second alarm message, in the case that the player operates the determination button 16, the effect control device 72 recognizes that the player inputs an intermission period, sets the determination result to YES, and performs intermission period input processing (step S30). More specifically, the effect control device 72 first displays an intermission period input screen shown in FIG. 9C on the reel portion display 2a with the image control IC 75 (step S30). On the intermission period input screen shown in FIG. 9C, numbers which indicate the intermission period (the portion shown by ΔΔ in the diagram) and letters, “enter” are displayed. These numbers and letters are selectable with a cursor C, and each time the selection button 15 is operated the cursor C moves back and forth from the numbers that show the intermission period to the letters “enter”. Note that FIG. 9C shows a condition in which the cursor C is positioned on the numbers, which show the intermission period. Then when the determination button 16 is operated in a condition in which the cursor C is positioned on the numbers, which show the intermission period, the numbers (unit: minutes), which show the intermission period advance one minute for each time the determination button 16 is operated. Also, when the determination button 16 is operated in a condition in which the cursor C is positioned on the letters “enter”, the effect control device 72 sets the intermission period currently displayed as the intermission period input by the player, and moves to the next processing. In this manner, the selection button 15 and the determination button 16 correspond to time period input means, in which a time period is input from outside the cabinet.

When the player inputs an intermission period in the intermission period input processing in step S30, the effect control device 72 compares the intermission period input in step S30 with the maximum intermission period corresponding to the time zone of the current time obtained from the RTC 78 in step S20 on the basis on the intermission period list stored in the program ROM 73, and determines whether the intermission period input by the player is within the maximum intermission period (step S31). Then, when the intermission period input by the player is shorter that the maximum intermission period, the determination result is YES, and the effect control device 72 stores the intermission period input by the player in a predetermined storage area in the work RAM 74 (step S32). On the other hand, when the intermission period input by the player exceeds the maximum intermission period, the determination result is NO, and the effect control device 72 displays a message, on the reel portion display 2a for a predetermined period (for example 10 seconds), like the one shown in FIG. 9D, to the effect that the intermission period input by the player cannot be set and thus the maximum intermission period for the current time zone will be set as the intermission period (step S33). Then, the effect control device 72 stores the maximum intermission period that corresponds to the time zone that the current time is in, in the predetermined storage area of the work RAM 74 (step S34). Hence, the processing in steps S31, S33 and S34 correspond to input time period correction means, which store a predetermined time period in the time period storage means (work RAM 74) in the case in which the time period input with the time period input means exceed the predetermined time period.

When the effect control device 72 causes the intermission period to be stored in the work RAM 74 in step S32 or S35, the effect control device 72 sets the intermission period stored in the work RAM 74 in the timer 80, and sets the intermission flag stored in the predetermined storage area in the work RAM 74 (more specifically, sets the value of the intermission flag to “1”) (step S 35). In this manner, the timer 80 starts to count down the intermission period set by the effect control device 72. The effect control device 72 displays an intermission in progress screen shown in FIG. 9E on the reel portion display 2a with the image control IC 75 (step S36). Here, the intermission in progress screen is one that is displayed on the reel portion display 2a so as to cause at least the recognition of display areas of the reel display windows 4L, 4C and 4R is in a difficult condition to the degree that the symbols on the reels 3L, 3C and 3R cannot be distinguished. Hence it is preferable to display “black” all over the reel display windows 4L, 4C and 4R (more specifically, a condition in which light is shut out completely). Also, if there is a condition in which the symbols on the reels 3L, 3C and 3R cannot be distinguished, then letters such as shown in FIG. 9E, “intermission in progress” or the like may be displayed.

By performing display in this manner, the symbols on the reels 3L, 3C and 3R cannot be seen, thus game itself can be continued, however, fundamental game cannot be performed and in effect the gaming machine 1 can be said to be in a condition in which game is not possible. Also, if communication from the sub control unit 60 to the main control unit 30 was made possible, the sub control unit 60 could also transmit intermission flag information to the main control unit 30, and the main control unit 30 would return the medals inserted from the medal insertion slot 10 to the medal tray 22 during the period in which the intermission flag is set, and would deactivate the operation of each type of BET switches 12 to 14, thus creating a condition in which more definitely game cannot be performed.

Also, on the intermission in progress screen shown in FIG. 9E, a remaining time period of the intermission period input by the player is displayed in a remaining time period display area TR in the display area of the reel display windows 4L, 4C and 4R, and the remaining time period is updated moment by moment with intermission period determination processing to be described next. Then, when the effect control device 72 displays the intermission in progress screen to the reel portion display 2a in step S36, the effect control device 72 ends the alarm time determination processing shown in FIG. 8 and returns to step S1 of the time setting indicating processing shown in FIG. 5.

Next an explanation will be given of the contents of the intermission period determination processing of step S2 in the time setting indicating processing shown in FIG. 5, with reference to FIG. 10. When the intermission flag stored in the predetermined storage location in the work RAM 74 is set in step S1 in FIG. 5, the determination result in step S1 is YES, and the effect control device 72 executes the intermission period determination processing shown in FIG. 10. First the effect control device 72 obtains the remaining time period of the intermission period from the timer 80 (step S40). Then the effect control device 72 determines whether the obtained remaining time period is “0” (step S41). Here, when the remaining time period of the intermission period is not “0”, the determination result is NO, and the effect control device 72 updates the value displayed on the remaining time period display area TR, which is part of the intermission in progress screen of FIG. 9D displayed on the reel portion display 2a, with the remaining time period obtained from the timer 80 (step S42). On the other hand, when the remaining time period of the intermission period obtained from the timer 80 is “0”, the determination result is YES, and the effect control device 72 changes the display on the reel portion display 2a from the intermission in progress screen to the prior game screen with the image control IC 75 (step S43). More specifically, the processing in which in step S36 in FIG. 8 the intermission in progress screen is displayed on the reel portion display 2a, and then in step S42 of FIG. 10 the reel portion display 2a is returned to the prior game screen corresponds to game disable means, which create a condition in which game cannot be performed on the gaming machine 1 during the period in which the time period measuring means (timer 80) is measuring the time period. Also, in effect a condition is created in which game on the gaming machine 1 is not possible during the intermission period set by the player, thus the intermission period can be more specifically termed game disable time period. Then the effect control device 72 clears the intermission period stored in the work RAM 74 (step S44), and resets the intermission flag (step S45), and then ends the intermission period determination processing of FIG. 10, and returns to step S1 of the time setting indicating processing shown in FIG. 5.

With the gaming machine 1 explained above, even if the player is performing game, there is no risk of the player forgetting the scheduled time or time period, and it is possible to omit a process for starting the intermission period, and the player can set an intermission period according to his convenience.

More specifically, when the time set by the player with the selection button 15 and the determination button 16 arrives, a message to that effect is displayed on the reel portion display 2a. Thus the possibility is removed of the player becoming too involved in the game and forgetting the time that the player scheduled. Also, when the player sets an intermission period with the selection button 15 and the determination button 16, the reel display windows 4L, 4C and 4R are in a difficult condition to recognize during the intermission, thus the gaming machine 1 is in effect in a condition in which game cannot be performed. Thus, the gaming machine 1 can be secured without the effort of calling a staff member of the game arcade when taking an intermission. Furthermore, the intermission period which is possible to be set by the player is limited by the maximum intermission period stored in the program ROM 73, thus the game arcade can provide a useful service to the player and can as much as possible prevent lowering of the efficiency of the gaming machine 1.

Also, the time zone and the maximum intermission period in the intermission prohibited time zone and the intermission period lists stored in the program ROM 73 are set as appropriate, thus for example, the upper limit of the intermission period can be set precisely according to the operating time period of the game arcade, more specifically, with shorter maximum intermission period in the time periods in which a number of players come, and with as long as possible maximum intermission period in the time periods in which less players come.

Note that in the embodiment described above the effect control device 72 displays the first alarm message to the reel portion display 2a in step S25 in FIG. 8, and thus creates a game disable condition in the gaming machine 1, and then when the effect control device 72 determines that the determination button 16 was operated in step S26, the effect control device 72 deactivates the game disable condition, however, the game disable condition may also be deactivated by the player inputting a password instead of operating the determination button 16. More specifically, for example, ten number buttons would be provided corresponding to each number from zero to nine on the pedestal portion 11 of the gaming machine 1, and at the time in which the effect control device 72 performs set time input processing in step S12 in FIG. 6, the effect control device 72 would set a password formed with numbers of a plurality of digits with the number buttons described above by the player. Then the effect control device 72 would store the set password in the work RAM 74, and in step S26 in FIG. 8 when numbers are input that are the same as the password stored in the work RAM 74, the determination result is YES, and the effect control device 72 would move to step S27 and display the game screen on the reel portion display 2a.

Also, in the embodiment described above, when the set alarm time arrives, it is possible to set an intermission period, however, an embodiment may also be implemented in which it is possible to set an intermission period at the time when setting the alarm time. In this case, when the alarm time arrives, the intermission period starts without any other operation. Also, in the present embodiment the RTC 78 and the timer 80 are provided separately, however, control may also be performed in the effect control device 72 to calculate an intermission end time on the basis of the set alarm time and intermission period, and when the calculated intermission end time arrives, the effect control device 72 creates a condition in which game is possible on the gaming machine 1. In this case there is no need to provide the timer 80.

Also, data which relate to intermission prohibited time zones and data which relate to intermission period lists are stored separately in the program ROM 73, however, all of the data may be consolidated into the intermission period list. In this case, the maximum intermission period would be set to “0” in time zones in which an intermission period cannot be set, and in the set screen, when a time is reached included in these time periods and in the case in which the player attempts to set an intermission period, that intermission period would be invalidated, and a message would be displayed on the screen of the reel portion display 2a, to the effect that this intermission period cannot be set. Also, processing may also be performed in which an upper limit of the number of times an intermission period can be set is provided, performed in which setting of an intermission period is not possible in the case in which a history of set intermission periods is stored and the total of the intermission periods exceeds a predetermined time period, performed in which setting of an intermission period is not possible in the case in which there was a set intermission period in a past predetermined time period when the player sets an intermission period, and the like.

Furthermore, in the present embodiment, a condition is created in the gaming machine 1 in which game is effectively not possible until the intermission period ends, however, an embodiment may be implemented in which for example, when an intermission period is set, the player is caused to set a password, and in case that the set password is input during the intermission period, a condition would be created in the gaming machine 1 in which game is possible.

What is claimed is:

1. A gaming machine which has a variable display device provided in a cabinet to variably display identification information of a plurality of types, and which performs game in which an award is provided to a player in accordance with a display state of the identification information displayed when a variable display in the variable display device stops, comprising:
a time input unit in which a time is inputted from outside the cabinet;
a time storage unit which stores the time inputted utilizing the time input unit;
a time measuring unit which measures a current time, which is operated on an internal power source; and
a time indicating unit which indicates that the time inputted has arrived when a determination is made that the current time measured by the time measuring unit is the inputted time stored in the time storage unit.

2. The gaming machine according to claim 1, further comprising:
a time period input unit in which a time period is inputted from outside the cabinet;
a time period storage unit which stores the time period inputted utilizing the time period input unit;
a time period measuring unit which measures the time period stored in the time period storage unit; and
a game disable unit which makes a condition in which the game cannot be performed while the time period measuring unit measures the time period stored in the time period storage unit.

3. The gaming machine according to claim 1, wherein the time indicating unit includes a display provided on a front surface side of the gaming machine.

4. The gaming machine according to claim 1, wherein the variable display device includes a plurality of rotating reels, and wherein the time indicating unit indicates when a condition exists in which rotation of all of the plurality of rotating reels is stopped.

5. The gaming machine according to claim 1, further comprising data that associates each time zone in which the player can obtain an intermission with a maximum intermission period that can be obtained, wherein the time indicating unit performs indicating only in a case in which the time inputted with the time input unit is a time in one of the time zones in which the intermission can be obtained.

6. The gaming machine according to claim 1, wherein the gaming machine is a slot machine.

7. The gaming machine according to claim 2, further comprising an input time period correction unit which stores a predetermined time period in the time period storage unit in place of a time period inputted with the time period input unit, when the time period inputted with the time period input unit exceeds the predetermined time period.

8. The gaming machine according to claim 2, wherein the variable display device includes a plurality of rotating reels, the time indicating unit is a display provided on a front side of the plurality of rotating reels, and the plurality of rotating reels are difficult to be seen from a front surface side of the gaming machine due to the display being in a light blocking condition while the game disable unit is measuring the time period stored in the time period storage unit.

9. The gaming machine according to claim 2, wherein the time indicating unit continuously indicates until a prescribed operation relating to the time period input is performed in the time period input unit.

10. The gaming machine according to claim 3, wherein the variable display device includes a plurality of rotating reels, the display is provided on a front side of the plurality of rotating reels, and the display is normally transparent so that the plurality of rotating reels are visible from the front surface side of the gaming machine, and on the other hand when the time indicating unit performs indicating, the plurality of rotating reels are difficult to see from the front surface side of the gaming machine due to the display being in a light blocking condition.
